(19) United States
(12) Patent Application Publication
(10) Pub. No.: US 2007/0296893 A1
(43) Pub. Date: Dec. 27, 2007

(54) LIQUID CRYSTAL DISPLAY DEVICES AND FABRICATION METHODS THEREOF

(75) Inventors: Yi-An Sha, Taipei City (TW); Wei-Ting Hsu, Tainan County (TW); Kang-Hung Liu, Hsinchu (TW); Ku-Hsien Chang, Kaohsiung County (TW); Pei-Ju Su, Hsinchu City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/562,950

(22) Filed: Nov. 22, 2006

(30) Foreign Application Priority Data
Jun. 23, 2006 (TW) TW95122649

(51) Int. Cl. G02F 1/1337

(52) U.S. Cl. 349/106; 349/128; 349/187

(57) ABSTRACT

Liquid crystal display devices and fabrication methods thereof. The liquid crystal display includes a first substrate, a second substrate and a liquid crystal layer interposed therebetween. A first alignment layer is disposed on the first substrate, and a second alignment layer is disposed on first alignment layer. A third alignment is disposed on the second substrate. Alignment orientations of liquid crystal molecules on the first and second alignment layers are different, and alignment orientations of liquid crystal molecules on the third and fourth alignment layers are different.

### BACKGROUND OF THE INVENTION

1. Field of the Invention

The invention relates to liquid crystal display (LCD) devices, and more particularly to LCD devices capable of achieving wide viewing angles by multiple alignments.

2. Description of the Related Art

Liquid crystal display (LCD) devices have several advantages over other display technologies, such as small volume, low weight, thinner profile, and low power consumption, and increased portability are applicable in a variety of electronic and communication devices including notebook computers, personal digital assistants (PDA), mobile phones and others.

Conventional LCD devices are limited by their narrow viewing angle such that their applications are also limited. To improve the viewing angle in LCD devices, multi-domain vertical alignment (MVA) liquid crystal display devices comprising bumps or protrusions on the substrate for creating different orientation of liquid crystal molecules have been introduced. Because different LC orientations can cause different electric field distributions in a single LC cell, of LC alignment and relaxation also change. Forming bumps or protrusions on the substrate, however, requires an intricate lithographic process. A half-tone mask may even be introduced to create bumps or protrusions on the substrate.

Another conventional method for improving the viewing angle in an MVA LCD device is provided by forming a slit or an opening in each pixel of the display device. Since the slit or the opening can cause different electric field distributions in a single LC cell, LC alignment and relaxation also change. Forming the slit or the opening in each pixel, however, requires an intricate lithographic process. The lithographic process must be performed in a vacuum thus increasing cost and reducing production yield.

Moreover, another conventional method for improving the viewing angle in an MVA LCD device is provided by adding chiral molecules in liquid crystal molecules. The additional chiral molecules can help LC molecule alignments horizontally. U.S. Pub. No. 2003/0234901, the entirety of which is hereby incorporated by reference, discloses an LCD device with protrusion structure and additional chiral molecules in LC layer to improve viewing angles. The boundary conditions of the multi-domain LC orientation, however, are difficult to decide and the domain of the horizontal LC molecule alignments are difficult to control.

Another conventional method for improving the viewing angle in an MVA LCD device is disclosed in an article “Multi-domain Vertically Aligned Nematic LCDs with Switchable Pixel Walls” by Cindy Nieuwkerk et al., SID conference 2005. The peripheral regions of each pixel are illuminated by UV light to trigger a photochemical reaction. Domains with different LC orientations are formed separately in the illuminated and unexposed regions to improve viewing angles. Additional photo reactors or photo catalysts must, however, be mixed into the alignment layer and use of the exposure apparatus results in higher production cost.

FIGS. 1A-1C are schematic views of a conventional method for improving the viewing angle in an MVA LCD device by UV irradiation. Referring to FIG. 1, a first substrate 10 with an alignment layer thereon is provided. The alignment layer includes additional photo reactors or photo catalysts. Part of the alignment layer illuminated by UV light comprises different LC orientation characteristics than that unexposed by the UV light, thereby creating multi-domains with different LC orientations in a single LC cell.

Referring to FIG. 1B, since the orientation between LC molecules and the exposed part of the alignment layer is changed, orientations of liquid crystal molecules on the unexposed alignment layer 12a and on the exposed alignment layer 12b are different. A second substrate 20 with an alignment layer thereon is provided. LC molecules 12c are homogeneously aligned on the second substrate 20. The first substrate 10 and the second substrate 20 are assembled with a liquid crystal layer therebetween. The exposed part of the LCD device is defined as a peripheral region E. The unexposed part of the LCD device is defined as a pixel region P. Since the surface characteristics of the peripheral region E and the pixel region P are different, orientations of the liquid crystal molecules corresponding to the first peripheral region E and the pixel region P are also different, creating multi-domains with different LC orientations in a single LC cell. Multi-domains with different LC orientations are formed separately in the illuminated and unexposed regions to improve viewing angles. Additional photo reactors or photo catalysts must, however, be mixed into the alignment layer and use of the exposure apparatus results in high production cost.

### BRIEF SUMMARY OF THE INVENTION

A detailed description is given in the following embodiments with reference to the accompanying drawings.

Accordingly, LCD devices, such as multi-domain vertical alignment (MVA) mode LCDs capable of different pre-tilt angles and/or multiple alignment regions of liquid crystal molecules in a single LCD are provided. By forming a protrusion structure and/or slit electrode structure in each pixel of the display device, multi-domains with different LC orientations are formed.

An exemplary embodiment of the invention provides a liquid crystal display device. A first substrate is disposed opposite a second substrate with a layer of liquid crystal molecules interposed therebetween. A first alignment layer is disposed on the first substrate. A second alignment layer is selectively disposed on the first alignment layer. A third alignment layer is disposed on the second substrate, wherein orientations of liquid crystal molecules on the first alignment layer and on the second alignment layer are different.

Another exemplary embodiment of the invention provides liquid crystal display device. A first substrate is disposed opposite a second substrate with a layer of liquid crystal molecules interposed therebetween. A first alignment layer is disposed on the first substrate. A second alignment layer is selectively disposed on the first alignment layer. A third alignment layer is disposed on the second substrate. A fourth alignment layer is selectively disposed on the third alignment layer, wherein orientations of liquid crystal molecules on the first alignment layer and on the second alignment layer are different.

The invention also provides a method for fabricating a liquid crystal display device, comprising providing a first substrate with an electrode structure thereon, applying a first alignment layer on the first substrate, selectively forming a second alignment layer on the first alignment layer, applying a first alignment layer on a first substrate, and assembling the first substrate and the second substrate and injecting a layer of liquid crystal molecules therebetween, wherein orientations of the liquid crystal molecules on the first alignment layer and on the second alignment layer are different.

The invention also provides a method for fabricating a liquid crystal display device, comprising providing a first substrate with an electrode structure thereon, applying a first alignment layer on the first substrate, selectively forming a second alignment layer on the first alignment layer, applying a first alignment layer on a first substrate, selectively forming a fourth alignment layer on the third alignment layer, and assembling the first substrate and the second substrate and injecting a layer of liquid crystal molecules therebetween, wherein orientations of the liquid crystal molecules on the first alignment layer and on the second alignment layer are different.

### BRIEF DESCRIPTION OF THE DRAWINGS

The invention can be more fully understood by reading the subsequent detailed description and examples with references made to the accompanying drawings, wherein:

FIGS. 1A-1C are schematic views of a conventional method for improving the viewing angle in an MVA LCD device by UV irradiation;

FIG. 2 is schematic view of applying an alignment layer on a substrate according to an embodiment of the invention;

FIG. 3 is a plan view illustrating the patterned alignment layer on a substrate formed by the step as shown in FIG. 2;

FIG. 4 is a cross section of forming a second alignment layer on the first patterned alignment layer according to an embodiment of the invention;

FIG. 5 is a cross section of a second patterned alignment layer on the first patterned alignment layer according to an embodiment of the invention;

FIG. 6A is a cross section of an exemplary embodiment of a liquid crystal display device including a substrate of FIG. 5;

FIG. 6B is a cross section of another exemplary embodiment of a liquid crystal display device including a substrate of FIG. 5;

FIG. 7A is a plan view of a wide viewing angle LCD device according to another embodiment of the invention; and

FIG. 7B is a cross section of the wide viewing angle LCD device taken along line I-I of FIG. 7A.

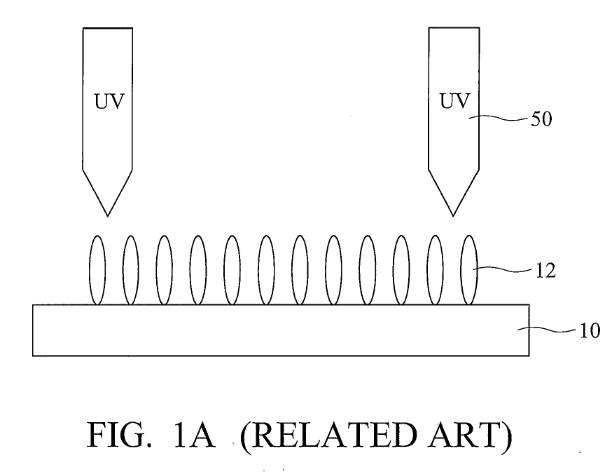

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

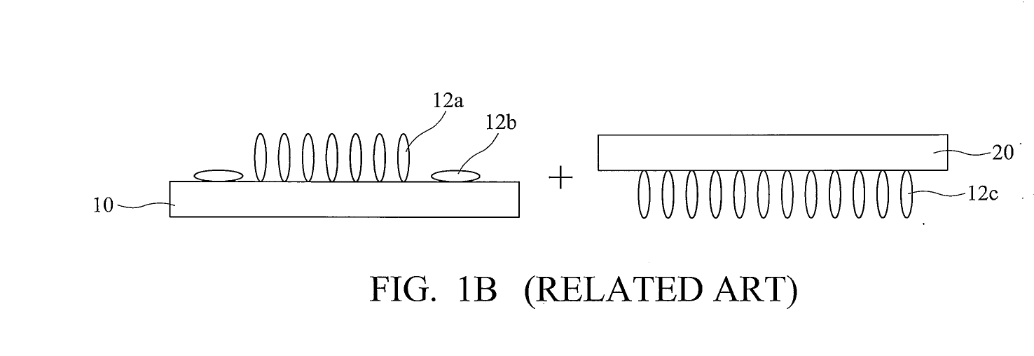

FIG. 2 is schematic view of applying an alignment layer on a substrate according to an embodiment of the invention. The alignment layer may comprise polyvinyl alcohol (PVA), polyimide (PI), polyamide (PA), polyurea (PU), nylon, or lecithin. The alignment layer is preferably applied by a roller on a large scale substrate.

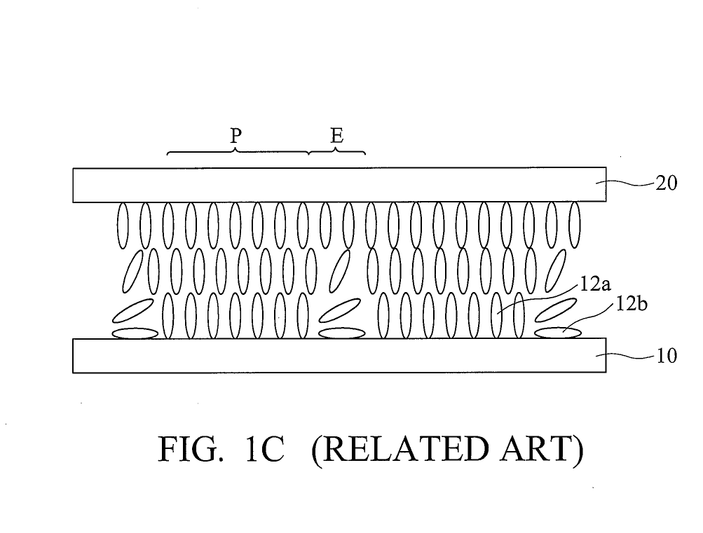

Referring to FIG. 3, a substrate 130 with an electrode layer or other elements such as color filters (not shown) is provided. The substrate 130 comprises a glass substrate, metal substrate, or a transparent plastic substrate. The substrate 130 further comprises an array of active control devices including thin film transistors (TFTs). The electrode comprises organic conductive material or inorganic conductive material. Alternatively, the substrate 130 can be an opposing substrate with a color filter layer thereon. Sequentially, a relief (or anastatic) printing plate with predetermined patterns is attached on a roller 110. A first patterned alignment layer 120 is preferably applied by the roller 110 on a large scale substrate 130.

Note that the first patterned alignment layer 120 of FIG. 3 is not limited to representing the entire display region of an LCD device. The first patterned alignment layer 120 may represent only a single pixel region or a plurality of pixel regions.

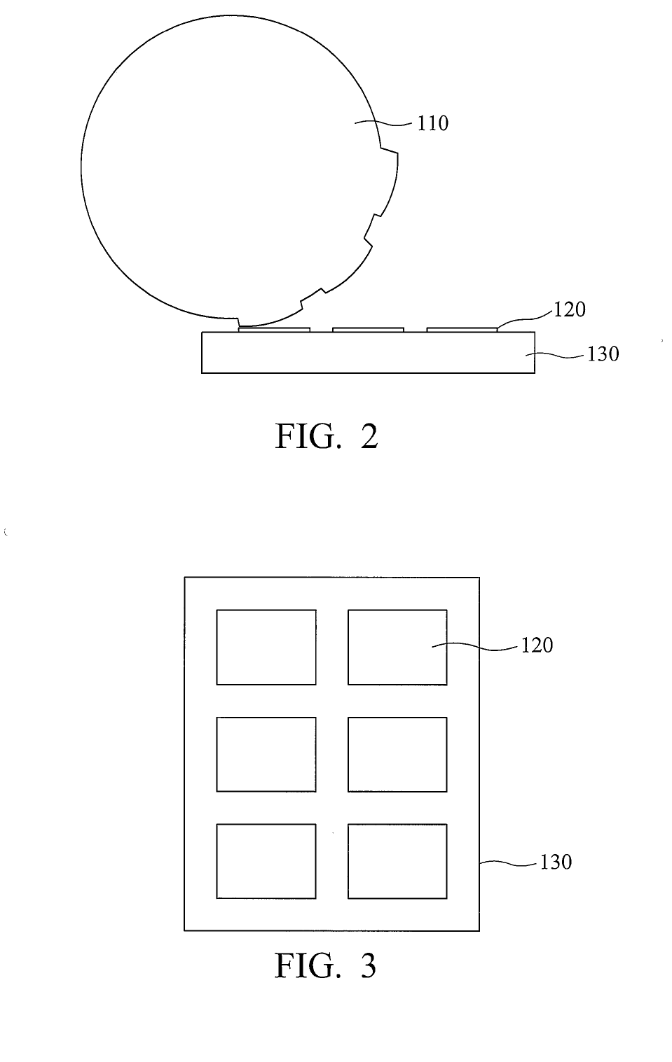

FIG. 4 is a cross section of forming a second alignment layer on the first patterned alignment layer according to an embodiment of the invention. Referring to FIG. 4, a second alignment layer 150′ is preferably applied on the first patterned alignment layer 120 by inkjet printing. For example, a fluid injector device 140, such as a thermal bubble driven inkjet printhead or a piezoelectric diaphragm driven inkjet printhead, can inject droplets 150 of alignment material on the first alignment layer 120. The location and dimensions of the second alignment layer 150′ can be achieved by controlling the position of the fluid injector device 140 and the volume of the droplet 150. The second alignment layer may comprise polyvinyl alcohol (PVA), polyimide (PI), polyamide (PA), polyurea (PU), nylon, or lecithin. An aligning procedure such as rubbing is subsequently performed after an 180° C. baking procedure.

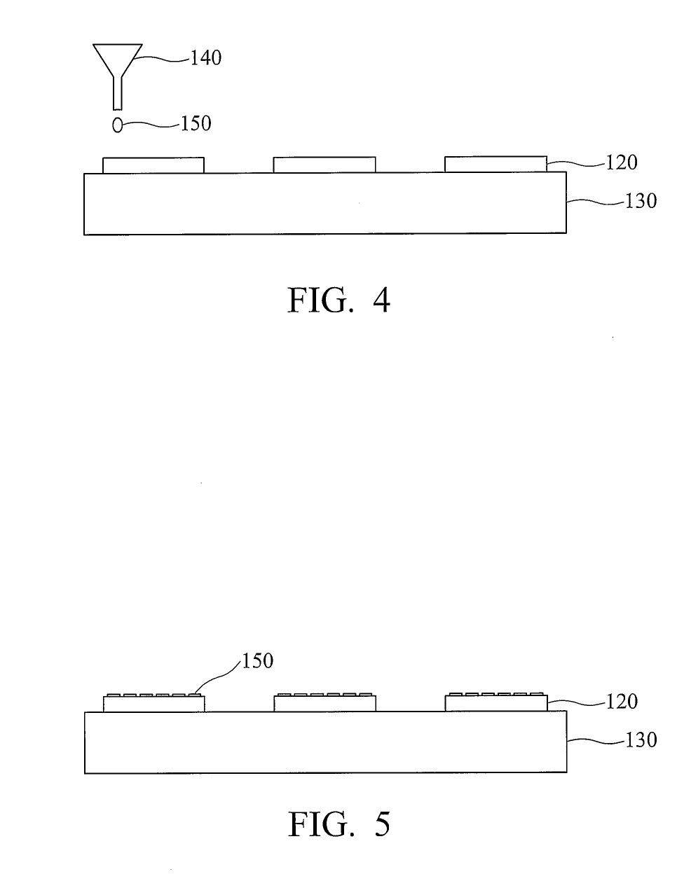

FIG. 5 is a cross section of a second patterned alignment layer on the first patterned alignment layer according to an embodiment of the invention. In FIG. 5, the second alignment material 150′ is precisely printed at predetermined sites on the first alignment layer 120, exposing part of the first alignment layer 120. By selecting different materials for the first and the second alignment layers, different liquid crystal orientations can be achieved in a single LCD device, thereby widening the viewing angle.

Accordingly, the relationship between the first and the second alignment layers depends on types of the LCD device, such as a multi-domain vertical alignment (MVA) mode LCD, an optically compensated birefringence (OCB) mode LCD, or a transflective mode LCD. For example, when applied to a transflective mode LCD, the second alignment layer 150′ is disposed on the reflective region, exposing the first alignment layer 120 at the transmission region. By selecting different materials for the first and the second alignment layers, different liquid crystal orientations can be achieved corresponding to the transmission and reflective regions separately, thereby improving display quality of the transflective LCD device.

Alternatively, the first and the second alignment layers can be selected from materials with different polarities, as different polarities can cause different liquid crystal orientations due to surface tensions between the alignment layers and the liquid crystal layer.

According to an embodiment of the invention, the first alignment layer 120 preferably provides a vertical liquid crystal molecule orientation, i.e., a longitudinal axis of the liquid crystal molecule is pre-tilted 75-90 degrees against the first alignment layer 120, while the second alignment layer 150′ provides a horizontal liquid crystal molecule orientation, i.e., a longitudinal axis of the liquid crystal molecule is pre-tilted 0-15 degrees against the second alignment layer 150′. Alternatively, the first alignment layer 120 provides a horizontal liquid crystal molecule orientation, i.e., a longitudinal axis of the liquid crystal molecule is pre-tilted 0-15 degrees against the alignment layer 70, while the second alignment layer 150′ provides a vertical liquid crystal molecule orientation, i.e., a longitudinal axis of the liquid crystal molecule is pre-tilted 75-90 degrees against the second alignment layer 150′.

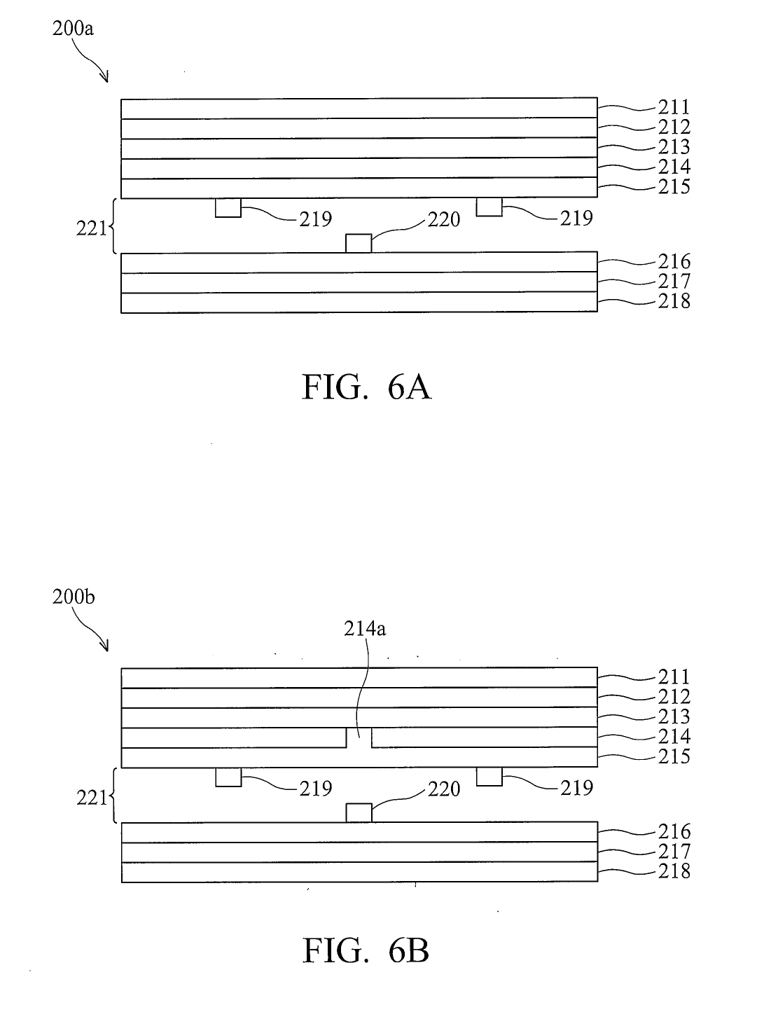

FIG. 6A is a cross section of an exemplary embodiment of a liquid crystal display device including a substrate of FIG. 5. Referring to FIG. 6A, a liquid crystal display device 200a comprises a first substrate 218, a second substrate 211 opposing the first substrate 218, and a liquid crystal layer 221 interposed between the first substrate 218 and the second substrate 211. The liquid crystal layer 221 comprises a positive nematic liquid crystal or a negative nematic liquid crystal. The liquid crystal layer 221 further comprises additional chiral molecules in liquid crystal molecules.

The first substrate 218 comprises an electrode layer 217 to serve as a pixel electrode controlling liquid crystal molecule orientations. A first alignment layer 216 is disposed on the first substrate 218. A second alignment layer 220 is selectively disposed on the first alignment layer 216, exposing part of the first alignment layer 216. The alignment orientations and pre-tilt angles of liquid crystal molecules on the first alignment layer 216 and on the second alignment layer 220 are different.

A black matrix (BM) layer 212 and a color filter layer 213 are disposed on the second substrate 211. An electrode layer 214 is disposed on the color filter layer 213 to serve as a common electrode controlling liquid crystal molecule orientations. A third alignment layer 215 is disposed on the electrode layer 214. A fourth alignment layer 219 is selectively disposed on the third alignment layer 215, exposing part of the third alignment layer 215. The alignment orientations and pre-tilt angles of liquid crystal molecules on the third alignment layer 215 and on the fourth alignment layer 219 are different. Note that the second alignment layer 220 and the fourth alignment layer 219 are staggered with each other.

A protrusion structure is preferably formed on the electrode structure 217. The first alignment layer 216 is formed on the protrusion structure. The electrode structure 217 comprises strip-shaped electrodes, comb-shaped electrodes, square-shaped electrodes, polygon-shaped electrodes or zigzag-shaped electrodes. The protrusion structure comprises structure comprises strip-shaped protrusions, comb-shaped protrusions, square-shaped protrusions, polygon-shaped protrusions or zigzag-shaped protrusions.

The second alignment layer 220 is formed by printing, or inkjet printing on the first alignment layer 216. Similarly, the fourth alignment layer 219 is formed by printing, or inkjet printing on the third alignment layer 215.

FIG. 6B is a cross section of another exemplary embodiment of a liquid crystal display device including a substrate of FIG. 5. The LCD device 200b in FIG. 6B is nearly identical to the LCD device 200a in FIG. 6A and a detailed description thereof is omitted for simplicity. The LCD device 200b in FIG. 6B is different from the LCD device 200a in FIG. 6A in that the electrode structure 214 comprises an opening 214a therein. The opening 214a can be a clear region or filled with an insulating material. Moreover, chiral molecules can be optionally added in liquid crystal molecules to improve multi-domain alignment orientations and pre-tilt angles of liquid crystal molecules.

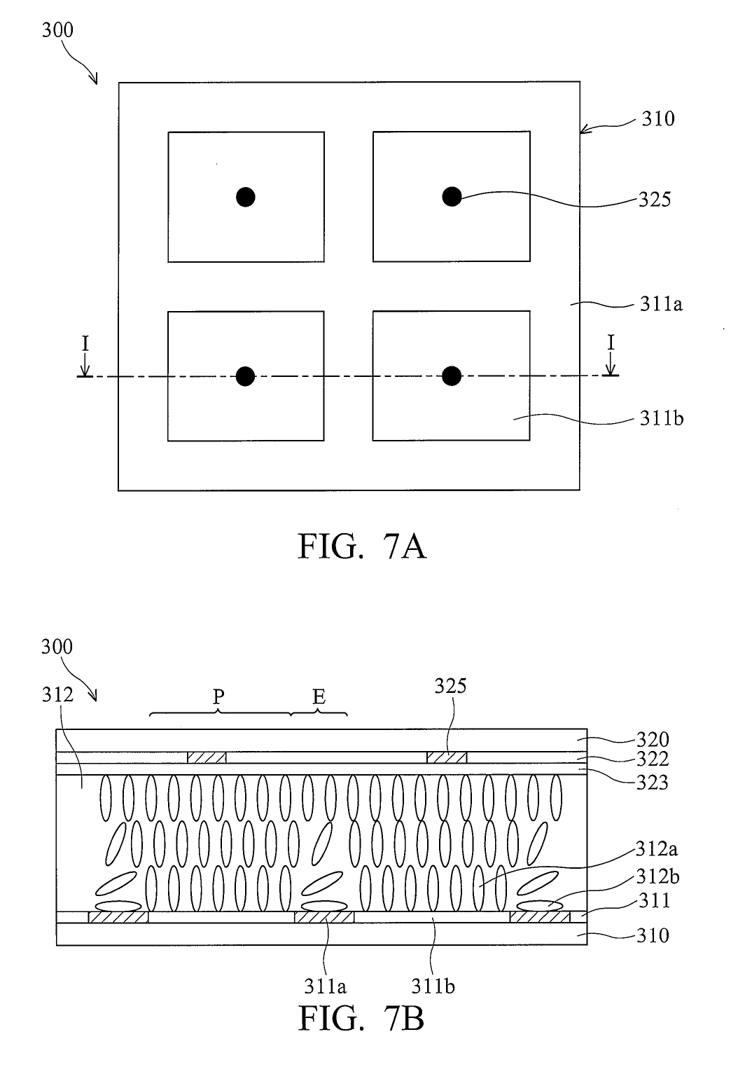

FIG. 7A is a plan view of a wide viewing angle LCD device according to another embodiment of the invention. FIG. 7B is a cross section of the wide viewing angle LCD device taken along line I-I of FIG. 7A. Referring to FIGS. 7A and 7B, a liquid crystal display device 300 comprises a first substrate 310, a second substrate 320 opposing the first substrate 310, and a liquid crystal layer 312 interposed between the first substrate 310 and the second substrate 320. The liquid crystal layer 312 comprises a positive nematic liquid crystal or a negative nematic liquid crystal. The liquid crystal layer 312 further comprises additional chiral molecules in liquid crystal molecules.

The first substrate 310 comprises an electrode structure (not shown) to serve as a pixel electrode controlling liquid crystal molecule orientations. The first substrate 310 comprises a pixel region P and a peripheral region E. A first alignment layer 311 comprises an alignment layer 311a on the pixel region P and another alignment layer 311b on the peripheral region E is disposed on the first substrate 310. The alignment orientations and pre-tilt angles of liquid crystal molecules on the alignment layer 311a and on the second alignment layer 311b are different.

An electrode structure 322 is disposed on the second substrate 320 to serve as a common electrode controlling liquid crystal molecule orientations. A third alignment layer 323 is disposed on the electrode structure 322. Liquid crystal molecules 312 are homogeneously aligned on the third alignment layer 323. The electrode structure 322 comprises an opening 325 therein. The opening 325 can be a clear region or filled with an insulating material. Moreover, chiral molecules can be optionally added in liquid crystal molecules to improve multi-domain alignment orientations and pre-tilt angles of liquid crystal molecules.

The invention is advantageous in that different pre-tilt angles and/or multiple alignment regions of liquid crystal molecules in a single LCD device, such as a multi-domain vertical alignment (MVA) mode LCD, can be achieved. Moreover, different alignment materials can be applied by different methods including relief (or anastatic) printing and inkjet printing at different regions, thereby improving viewing angle, bright, contrast ratio, and aperture of the LCD device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display device, comprising:
a first substrate opposite a second substrate with a layer of liquid crystal molecules interposed therebetween;
a first alignment layer disposed on the first substrate;
a second alignment layer selectively disposed on the first alignment layer; and
a third alignment layer disposed on the second substrate;
wherein orientations of liquid crystal molecules on the first alignment layer and on the second alignment layer are different.

2. The liquid crystal display device as claimed in claim 1, wherein the first substrate is an active matrix array substrate.

3. The liquid crystal display device as claimed in claim 1, wherein the first substrate is a color filter substrate comprising a color filter structure thereon.

4. The liquid crystal display device as claimed in claim 3, further comprising an electrode structure disposed on the color filter structure, and wherein the first alignment layer is disposed on the electrode structure.

5. The liquid crystal display device as claimed in claim 4, wherein the electrode structure comprises a protrusion structure thereon, and wherein the first alignment layer is disposed on the protrusion structure.

6. The liquid crystal display device as claimed in claim 4, wherein the electrode structure comprises strip-shaped electrodes, comb-shaped electrodes, square-shaped electrodes, polygon-shaped electrodes or zigzag-shaped electrodes.

7. The liquid crystal display device as claimed in claim 5, wherein the protrusion structure comprises structure comprises strip-shaped protrusions, comb-shaped protrusions, square-shaped protrusions, polygon-shaped protrusions or zigzag-shaped protrusions.

8. The liquid crystal display device as claimed in claim 1, wherein the first alignment layer and the second alignment layer have different polarities.

9. The liquid crystal display device as claimed in claim 1, wherein the second alignment layer is formed by printing, or inkjet printing on the first alignment layer.

10. The liquid crystal display device as claimed in claim 1, wherein the layer of liquid crystal molecules comprises a positive nematic liquid crystal or a negative nematic liquid crystal.

11. The liquid crystal display device as claimed in claim 10, wherein the layer of liquid crystal molecules further comprises addition chiral molecules in liquid crystal molecules.

12. The liquid crystal display device as claimed in claim 4, wherein the electrode structure comprises an opening, thereby resulting in a non-uniform electric field distribution in the liquid crystal layer.

13. The liquid crystal display device as claimed in claim 4, wherein the first substrate comprises a pixel region and a peripheral region, and wherein the second alignment layer is disposed on the peripheral region.

14. The liquid crystal display device as claimed in claim 1, wherein the first alignment layer provides a vertical liquid crystal molecule orientation, wherein a longitudinal axis of the liquid crystal molecule is pre-tilted 75°-90° against the first alignment layer; and wherein the second alignment layer provides a horizontal liquid crystal molecule orientation, wherein a longitudinal axis of the liquid crystal molecule is pre-tilted 0°-15° against the second alignment layer.

15. The liquid crystal display device as claimed in claim 1, wherein the first alignment layer provides a horizontal liquid crystal molecule orientation, wherein a longitudinal axis of the liquid crystal molecule is pre-tilted 0°-15° against the first alignment layer; and wherein the second alignment layer provides a vertical liquid crystal molecule orientation, wherein a longitudinal axis of the liquid crystal molecule is pre-tilted 75°-90° against the second alignment layer.

16. A liquid crystal display device, comprising:
a first substrate opposite a second substrate with a layer of liquid crystal molecules interposed therebetween;
a first alignment layer disposed on the first substrate;
a second alignment layer selectively disposed on the first alignment layer;
a third alignment layer disposed on the second substrate;
a fourth alignment layer selectively disposed on the third alignment layer; and
wherein orientations of liquid crystal molecules on the first alignment layer and on the second alignment layer are different.

17. The liquid crystal display device as claimed in claim 16, wherein the first substrate is an active matrix array substrate.

18. The liquid crystal display device as claimed in claim 16, wherein the first substrate is a color filter substrate comprising a color filter structure thereon.

19. The liquid crystal display device as claimed in claim 18, further comprising an electrode structure disposed on the color filter structure, and wherein the first alignment layer is disposed on the electrode structure.

20. The liquid crystal display device as claimed in claim 19, wherein the electrode structure comprises a protrusion structure thereon, and wherein the first alignment layer is disposed on the protrusion structure.

21. The liquid crystal display device as claimed in claim 19, wherein the electrode structure comprises strip-shaped electrodes, comb-shaped electrodes, square-shaped electrodes, polygon-shaped electrodes or zigzag-shaped electrodes.

22. The liquid crystal display device as claimed in claim 20, wherein the protrusion structure comprises structure comprises strip-shaped protrusions, comb-shaped protrusions, square-shaped protrusions, polygon-shaped protrusions or zigzag-shaped protrusions.

23. The liquid crystal display device as claimed in claim 16, wherein the second alignment layer and the fourth alignment layer are staggered with each other.

24. The liquid crystal display device as claimed in claim 16, wherein the first alignment layer and the second alignment layer have different polarities, and wherein the third alignment layer and the fourth alignment layer have different polarities.

25. The liquid crystal display device as claimed in claim 16, wherein the second alignment layer is formed by printing, or inkjet printing on the first alignment layer.

26. The liquid crystal display device as claimed in claim 16, wherein the layer of liquid crystal molecules comprises a positive nematic liquid crystal or a negative nematic liquid crystal.

27. The liquid crystal display device as claimed in claim 26, wherein the layer of liquid crystal molecules further comprises addition chiral molecules in liquid crystal molecules.

28. The liquid crystal display device as claimed in claim 19, wherein the electrode structure comprises an opening, thereby resulting in a non-uniform electric field distribution in the liquid crystal layer.

29. The liquid crystal display device as claimed in claim 16, wherein the first substrate comprises a pixel region and a peripheral region, and wherein the second alignment layer is disposed on the peripheral region.

30. The liquid crystal display device as claimed in claim 16, wherein the first alignment layer provides a vertical liquid crystal molecule orientation, wherein a longitudinal axis of the liquid crystal molecule is pre-tilted 75°-90° against the first alignment layer; and wherein the second alignment layer provides a horizontal liquid crystal molecule orientation, wherein a longitudinal axis of the liquid crystal molecule is pre-tilted 0°-15° against the second alignment layer.

31. The liquid crystal display device as claimed in claim 16, wherein the first alignment layer provides a horizontal liquid crystal molecule orientation, wherein a longitudinal axis of the liquid crystal molecule is pre-tilted 0°-15° against the first alignment layer; and wherein the second alignment layer provides a vertical liquid crystal molecule orientation, wherein a longitudinal axis of the liquid crystal molecule is pre-tilted 75°-90° against the second alignment layer.

32. A method for fabricating a liquid crystal display device, comprising:
providing a first substrate with an electrode structure thereon;
applying a first alignment layer on the first substrate;
selectively forming a second alignment layer on the first alignment layer;
applying a third alignment layer on the second substrate; and
assembling the first substrate and the second substrate and injecting a layer of liquid crystal molecules therebetween,
wherein orientations of the liquid crystal molecules on the first alignment layer and on the second alignment layer are different.

33. The method as claimed in claim 32, wherein the step of applying a first alignment layer comprises rolling, spin coating, spraying, or ink-j et printing.

34. The method as claimed in claim 32, after the step of applying the first alignment layer, further comprising a soft baking procedure.

35. The method as claimed in claim 32, after the step of applying the first alignment layer, further comprising a soft baking procedure and a hard baking procedure.

36. The method as claimed in claim 32, wherein the second alignment layer is formed by spraying or ink-jet printing on the first alignment layer.

37. The method as claimed in claim 32, after the step of forming the second alignment layer on the first alignment layer, further comprising a soft baking procedure and a hard baking procedure.

38. The method as claimed in claim 32, wherein the first alignment layer and the second alignment have different polarities.

39. The method as claimed in claim 32, wherein the electrode structure comprises a protrusion structure thereon, and wherein the first alignment layer is disposed on the protrusion structure.

40. The method as claimed in claim 32, wherein the layer of liquid crystal molecules comprises a positive nematic liquid crystal or a negative nematic liquid crystal.

41. The method as claimed in claim 40, wherein the layer of liquid crystal molecules further comprises addition chiral molecules in liquid crystal molecules.

42. The method as claimed in claim 32, wherein the electrode structure comprises an opening, thereby resulting in a non-uniform electric field distribution in the liquid crystal layer.

43. The method as claimed in claim 32, wherein the first substrate comprises a pixel region and a peripheral region, and wherein the second alignment layer is disposed on the peripheral region.

44. The method as claimed in claim 32, wherein the first alignment layer provides a vertical liquid crystal molecule orientation and the second alignment layer provides a horizontal liquid crystal molecule orientation.

45. The method as claimed in claim 32, wherein the first alignment layer provides a vertical liquid crystal molecule orientation, wherein a longitudinal axis of the liquid crystal molecule is pre-tilted 75°-90° against the first alignment layer; and wherein the second alignment layer provides a horizontal liquid crystal molecule orientation, wherein a longitudinal axis of the liquid crystal molecule is pre-tilted 0°-15° against the second alignment layer.

46. The method as claimed in claim 32, wherein the first alignment layer provides a horizontal liquid crystal molecule orientation, wherein a longitudinal axis of the liquid crystal molecule is pre-tilted 0°-15° against the first alignment layer; and wherein the second alignment layer provides a vertical liquid crystal molecule orientation, wherein a longitudinal axis of the liquid crystal molecule is pre-tilted 75°-90° against the second alignment layer.

47. The method as claimed in claim 32, further comprising selectively forming a fourth alignment layer on the third alignment layer.

48. The method as claimed in claim 47, wherein the second alignment layer and the fourth alignment layer are staggered with each other.

49. A method for fabricating a liquid crystal display device, comprising:
providing a first substrate with an electrode structure thereon;
applying a first alignment layer on the first substrate;
selectively forming a second alignment layer on the first alignment layer;
applying a first alignment layer on a first substrate;
selectively forming a fourth alignment layer on the third alignment layer; and
assembling the first substrate and the second substrate and injecting a layer of liquid crystal molecules therebetween,
wherein orientations of the liquid crystal molecules on the first alignment layer and on the second alignment layer are different.
